(19) United States
(12) Patent Application Publication
(10) Pub. No.: US 2005/0217054 A1
(43) Pub. Date: Oct. 6, 2005

(54) Wiper blade connecting structure

(75) Inventors: Tomohiro Ohe, Shioya-gun (JP); Mamoru Kagawa, Kawachi-gun (JP)

Correspondence Address: RANKIN, HILL, PORTER & CLARK LLP, 4080 ERIE STREET, WILLOUGHBY, OH, 44094-7836, US

(73) Assignee: Honda Motor Co., Ltd., Tokyo (JP)

(21) Appl. No.: 11/096,848

(22) Filed: Apr. 1, 2005

(30) Foreign Application Priority Data
Apr. 6, 2004 (JP) 2004-112191

(51) Int. Cl. B60S 1/40

(52) U.S. Cl. 15/250.32; 15/250.351; 15/250.44

(57) ABSTRACT

A wiper blade connecting structure having a wiper arm; and a supporting plate which is rotatably attached to the wiper arm and is covered by the wiper arm. A wiper blade is attached to the supporting plate and is rotatably supported via the supporting plate by the wiper arm. The supporting plate is contained in the wiper arm, and is not exposed and can be a small part. Typically, the wiper arm has a work hole for fastening the supporting plate to the wiper blade. The structure may include a cover member for covering the work hole, wherein the cover member has a fitting portion which is rotatably fit to a rotation shaft of the supporting plate. The structure may include a spacer mounted to the supporting plate, wherein the spacer has an extension which extends along a surface of the wiper blade.

### BACKGROUND OF THE INVENTION

1. Field of the Invention

The present invention relates to a wiper blade connecting structure, and in particular, a structure having a neat appearance and enabling easy attachment of a wiper blade.

Priority is claimed on Japanese Patent Application No. 2004-112191, filed Apr. 6, 2004, the content of which is incorporated herein by reference.

2. Description of Related Art

Generally, in a wiper apparatus provided in a vehicle such as an automobile, a wiper blade is rotatably supported at the head of a wiper arm. When attaching the wiper blade to the wiper arm, a clip may be attached to the wiper blade so as to attach the wiper blade via the clip to the wiper arm (see Japanese Unexamined Patent Application, First Publication No. H10-181540). Due to such a clip, attachment can be easily performed.

However, in the conventional wiper blade connecting structure explained above, the clip causes an increase in the height dimension and thus results in a large support for supporting the wiper blade, thereby (i) degrading the appearance of the wiper blade, (ii) resulting in a complicated structure, and (iii) increasing the number of necessary parts and the number of processes for mounting the wiper blade.

### SUMMARY OF THE INVENTION

In view of the above circumstances, an object of the present invention is to provide a wiper blade connecting structure for improving appearance when viewed from the interior of the vehicle, and for making attachment easy.

Therefore, the present invention provides a wiper blade connecting structure comprising:

a wiper arm (e.g., a wiper arm 14 in an embodiment explained later); and

a supporting plate (e.g., a joint holder 70 in the embodiment) which is rotatably attached to the wiper arm and is covered by the wiper arm, wherein

a wiper blade (e.g., a wiper blade 13 in the embodiment) is attached to the supporting plate and is rotatably supported via the supporting plate by the wiper arm.

According to the above structure, the supporting plate is contained in the wiper arm, and is not exposed and can be a small part, thereby improving the appearance of a portion for supporting the wiper blade.

Preferably, the wiper arm has a work hole (e.g., a work hole 61 in the embodiment) for fastening the supporting plate to the wiper blade. Accordingly, in order to mount the wiper blade, the supporting plate (attached to the wiper arm) can be fastened to the wiper blade via the work hole of the wiper arm. Therefore, it is possible to easily perform attachment of the wiper blade.

The wiper blade connecting structure may further comprise a cover member (e.g., a shank cover 53 in the embodiment) for covering the work hole, wherein the cover member has a fitting portion (e.g., holders 56 in the embodiment) which is rotatably fit to a rotation shaft (e.g., a rivet 63 in the embodiment) of the supporting plate. According to pushing an end portion of the cover member, the cover member is rotated via the fitting portion around the rotation shaft of the supporting plate, thereby easily removing the cover member. In addition, the rotated cover member is fit via the fitting portion to the rotation shaft of the supporting plate; thus, the rotating cover member does not fall from the wiper arm. Therefore, it is easy to handle the cover member.

The wiper blade connecting structure may further comprise a spacer (e.g., a joint spacer 31 in the embodiment) mounted to the supporting plate, wherein the spacer has an extension (e.g., an extension 31a in the embodiment) which extends along a surface of the wiper blade. Accordingly, the joint portion between the wiper arm and the wiper blade can be covered, thereby achieving continuity in appearance from the wiper arm to the wiper blade. Therefore, it is possible to reduce whistling sound in wiping operation and to improve the quality of appearance.

In the wiper blade connecting structure, a support (e.g., a support 76 in the embodiment) for supporting a rotation shaft of the supporting plate may be provided in the supporting plate, in a manner such that the supporting plate has a shorter portion further from a base side of the wiper arm and a longer portion closer to the base side of the wiper arm on opposite sides of the support, thereby stably holding the wiper blade.

### BRIEF DESCRIPTION OF THE DRAWINGS

FIG. 1 is a perspective view of a front portion of a vehicle, to which an wiper apparatus is attached, in an embodiment of the present invention.

FIG. 2 is a perspective view omitting the hood and the upper cowl top garnish in FIG. 1.

FIG. 3 is a front view of the wiper apparatus 3.

FIG. 4 is a plan view of the wiper apparatus 3.

FIG. 5 is an exploded front view of FIG. 3.

FIG. 6 is a perspective view showing the head of the shank.

FIG. 7 is an exploded perspective view of an attachment portion of the wiper blade.

FIG. 8 is a sectional view of a support of the wiper blade when the wiper blade rotates according to the upward rotation of the shank.

FIG. 9 is a sectional view corresponding to FIG. 8, for showing open/close states of the shank cover.

FIG. 10 is a perspective view of the shank cover.

### DETAILED DESCRIPTION OF THE INVENTION

Hereinafter, embodiments according to the present invention will be explained with reference to the drawings.

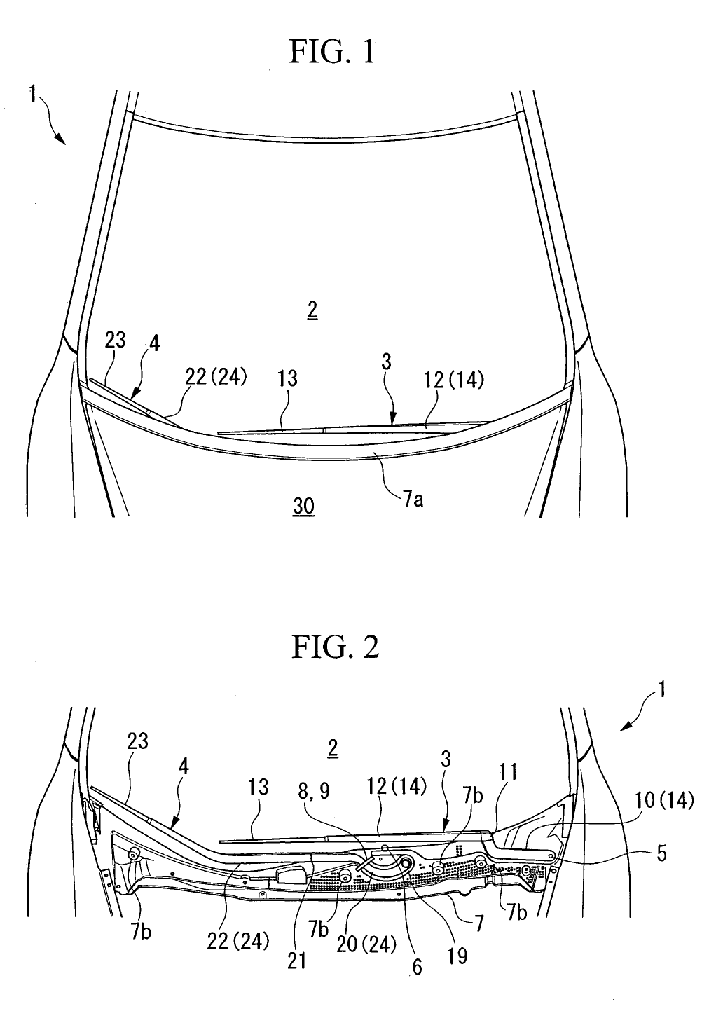

FIG. 1 is a perspective view of a front portion of a vehicle, to which an wiper apparatus is attached, in an embodiment of the present invention. FIG. 2 is a perspective view omitting the hood and the upper cowl top garnish in FIG. 1.

As shown in FIGS. 1 and 2, in a vehicle 1, a pair of wiper apparatuses 3 and 4 is provided so as to wipe a windshield 2. The wiper apparatuses 3 and 4 are respectively linked with pivots 5 and 6 which are rotated by driving devices (not shown).

The first wiper apparatus 3 is provided at the vehicle body's left side, and the pivot 5 of the wiper apparatus 3, positioned at the end proximate to the vehicle body's left side as shown in FIG. 2, protrudes from a cowl top garnish 7 which is arranged at the lower side of the windshield 2 and oriented in the width direction of the vehicle. An arm base 10 is attached to the pivot 5, and a shank 12 is supported via a hinge 11 at the arm base 10 in a manner such that the shank 12 can be elastically raised. A wiper blade 13 is rotatably supported at the head of the shank 12. Therefore, the wiper arm 14 of the first wiper apparatus 3 consists of the arm base 10 and the shank 12.

The second wiper apparatus 4 is provided at the vehicle body's right side and has a spindle 19 at a position slightly toward the vehicle body's left side from the center. This spindle 19 moves along an arc around the pivot 6 as the center axis, where the pivot 6 is provided at the back side of the cowl top garnish 7. An arc-shaped arm base 20 is attached to the spindle 19, and a shank 22 is supported via a hinge 21 at the head of the arc-shaped arm base 20 in a manner such that the shank 22 can be elastically raised. A wiper blade 23 is rotatably supported at the head of the shank 22. Reference numeral 7a indicates an upper cowl top garnish attached to attachment portions 7b of the cowl top garnish 7. The arc-shaped arm base 20 is inserted through a through hole 9, formed in a vertical wall 8 which is provided in the upper cowl top garnish 7a, toward the windshield 2. The wiper arm 24 of the second wiper apparatus 4 consists of the arm base 20 and the shank 22.

As shown in FIG. 1, the base sides of the wiper apparatuses 3 and 4 and most parts of the cowl top garnish 7 are covered by a rear edge portion of the closed hood 30.

The first wiper apparatus 3 and the second wiper apparatus 4 have substantially the same structures for the shanks (12 and 22) and for the wiper blades (13 and 23), and only have differences in the structures of the arm base 10 and the arc-shaped arm base 20 and in the shapes of the shank 12 and the curved shank 22. Therefore, the first wiper apparatus 3 will be representatively explained below.

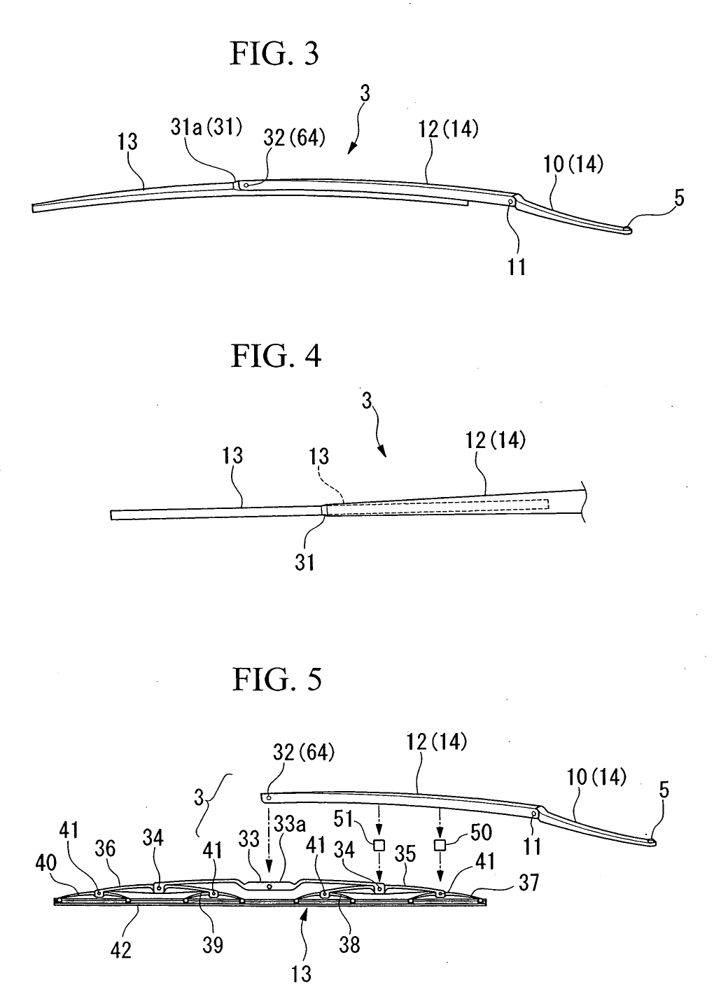

FIGS. 3 and 4 are a front view and a plan view of the wiper apparatus 3. As shown in the figures, in the first wiper apparatus 3, the shank 12 has a U-shaped section and is made of metal, and the wiper blade 13 is arranged at the inside of the shank 12 and is rotatably supported at the head of the shank 12.

As explained above, the shank 12 is supported by the arm base 10, in a manner such that the shank 12 can be elastically raised. Therefore, when, for example, cleaning the windshield 2, the shank 12 can be bent via the hinge 11 so as to stand while opposing a spring (not shown).

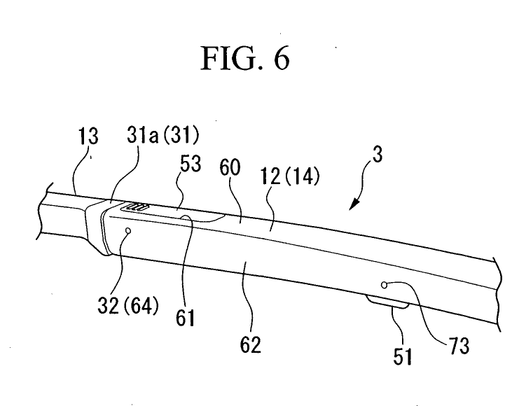

FIG. 5 is an exploded front view of FIG. 3, and FIG. 6 is a perspective view showing the head of the shank 12.

As shown in FIG. 6, at the head of the shank 12, a joint spacer 31 made of a resin (explained later) is provided, which adjoins the wiper blade 13. The extension 31a of the joint spacer 31 covers a gap between the wiper blade 13 and the head of the shank 12 to describe a continuity between the two.

As shown in FIG. 5, the wiper blade 13 has a primary arm 33 supported via a pin 32 by the shank 12, and two secondary arms 35 and 36 which are respectively rotatably supported at both ends of the primary arm 33 via pins 34. At either end of the secondary arm 35, yokes 37 and 38 are rotatably supported via pins 41, and similarly, yokes 39 and 40 are rotatably supported via pins 41 at either end of the secondary arm 36, thereby realizing a tournament structure. A blade body 42 is fastened to both ends of each of the four yokes 37, 38, 39, and 40.

Between the shank 12 of the wiper arm 14 and the wiper blade 13, a first stabilizer 50 and a second stabilizer 51 are inserted in turn in a line from the base side to the rotation side of the first wiper apparatus 3. Each stabilizer has a U-shaped section and has a form fittable to the inside of the shank 12.

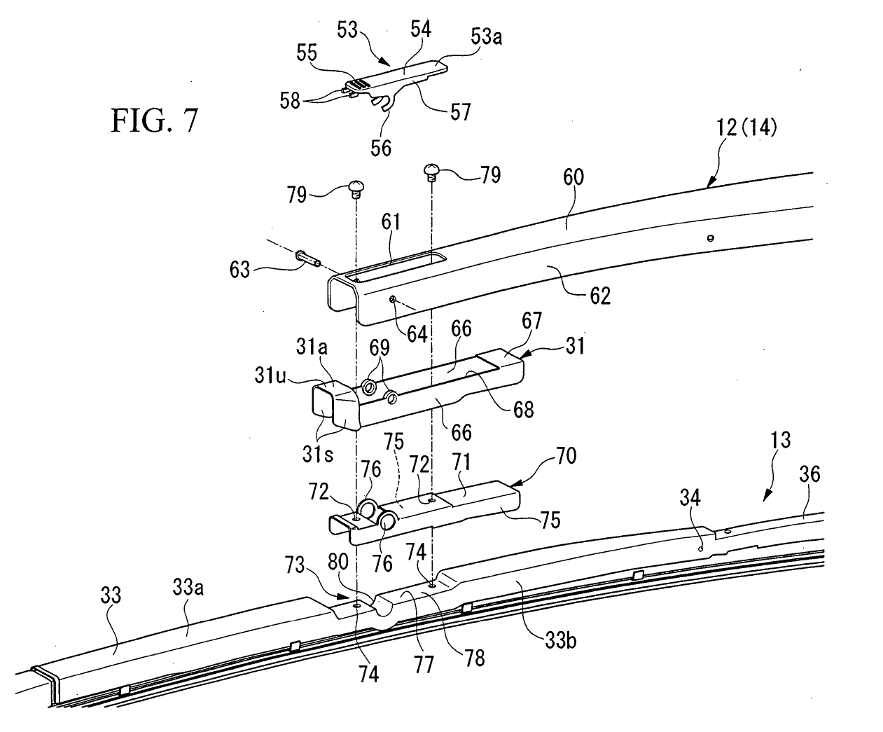

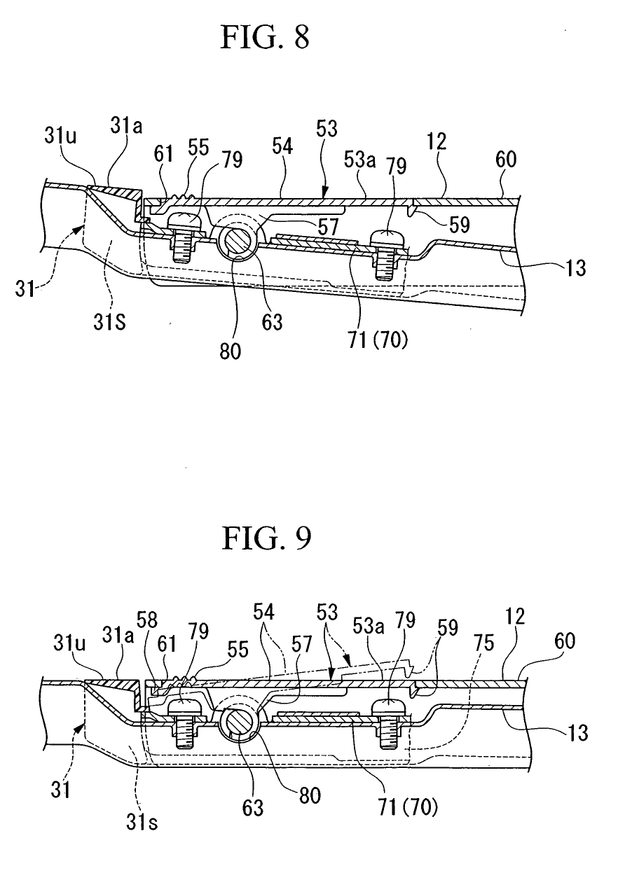

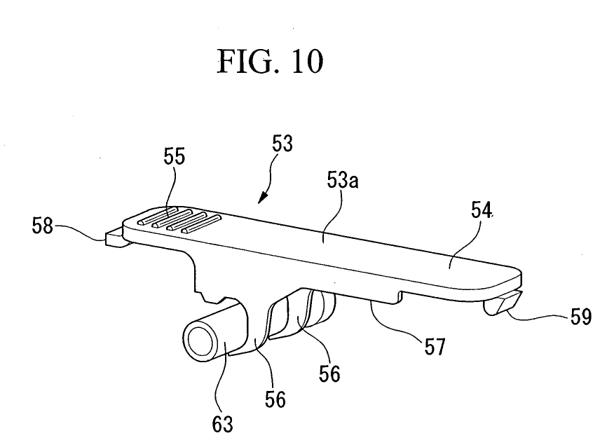

Next, the connection structure of the wiper arm 14 and the wiper blade 13 will be explained in detail by referring to FIGS. 7 to 10. FIG. 7 is an exploded perspective view of an attachment portion of the wiper blade. FIG. 8 is a sectional view of a support of the wiper blade when the wiper blade rotates according to the upward rotation of the shank. FIG. 9 is a sectional view corresponding to FIG. 8, for showing open/close states of the shank cover. FIG. 10 is a perspective view of the shank cover.

As shown in FIG. 7, the shank 12 of the wiper arm 14 has a U-shaped section and is made of metal, and a work hole 61 having a rectangular shape is formed in a head portion of the upper wall 60 of the shank 12. In head portions of both side walls 62 and 62 of the shank 12, attachment holes 64 and 64 are formed, through which a rivet 63 (functioning as the rotation shaft) is inserted and fixed. The attachment holes 64 are positioned close to the head end of the shank 12 with respect to the position of the work hole 61.

At the inside of the shank 12, a joint spacer 31 having a U-shaped section is arranged along the inner wall of the shank 12. The joint spacer 31, made of a resin, has a rectangular hole 68 formed by removing a part of the upper wall 67 thereof (see FIG. 7), where the rectangular hole 68 is larger than the work hole 61 of the shank 12. At the top end of the joint spacer 31, an extension upper wall 31u is formed, which slightly inclines downward. Extension side walls 31s, extending from the extension upper wall 31u, are each tapered. The extension upper wall 31u and extension side walls 31s form the extension 31a which extends from the end of the shank 12 and wraps a portion of the outside faces of the wiper blade 13, that is, a portion of the upper wall 33a and the side walls 33b of the primary arm 33.

In the side walls 66 and 66 of the joint spacer 31, shaft supports 69 and 69 having a ring shape are formed at positions corresponding to the positions of the attachment holes 64 for the rivet 63, so that the rivet 63 is inserted through the shaft supports 69 and 69, and the joint spacer 31 is rotatably supported via the rivet 63.

At the inside of the joint spacer 31, a joint holder 70 (i.e., a supporting plate) is mounted, which also has a U-shaped section, and is made of metal. In the upper wall 71 of the joint holder 70, two through holes 72 are formed, which are exposed through the hole 68 of the joint spacer 31 and also through the work hole 61 of the shank 12. The through holes 72 are provided for screws which are screwed into screw holes 74 provided in a support 73 (explained later) of the primary arm 33 of the wiper blade 13.

In the side walls 75 and 75 of the joint holder 70, ring-shaped supports 76 are formed at positions corresponding to the positions of the shaft supports 69 of the joint spacer 31.

Both the shaft supports 69 of the joint spacer 31 and the supports 76 of the joint holder 70 are close to the top end of the shank 12. Even when a half of the wiper blade, which is further from the base side of the shank 12 (i.e., the half at the left side in FIG. 7), rotates upward, and accordingly the other half closer to the base side of the shank 12 (i.e., the half at the right side in FIG. 7) rotates downward and is thus not supported by the side walls of the shank 12, this other half portion is reliably supported via the shaft supports 69 and the supports 76.

The joint holder 70 is mounted at the inside of the joint spacer 31, and the positions of the shaft supports 69 of the joint spacer 31 are matched with the positions of the supports 76 of the joint holder 70. In this state, the joint spacer 31 and the joint holder 70 are mounted to the shank 12 via the attachment holes 64 by the rivet 63. Therefore, the joint spacer 31 and the joint holder 70 are rotatably supported by the shank 12, and owing to the joint spacer 31, the joint holder 70 does not directly contact the inner faces of the side walls 62 of the shank 12.

The support 73 of the primary arm 33 is attached to the joint holder 70 via the through holes 72 of the joint holder 70. The support 73 is provided by forming a slightly concave portion in the upper wall 33a. That is, in the support 73 (of the primary arm 33) to which the joint holder 70 is attached, a concave portion 77 is formed, the bottom wall 78 of which has the above-explained screw holes 74 into which the screws 79 are screwed and fixed. In the bottom wall 78, a groove 80 having a semicircular cross-section is formed for receiving the rivet 63. According to the groove 80 and the concave portion 77, the attached wiper blade 13 can be mounted inside the shank 12 so as to reduce the height dimension of the combination of the wiper blade 13 and the wiper arm 14.

As shown in FIG. 10, a shank cover 53 (i.e., a cover member) for closing the work hole 61 of the shank 12 is detachably attached to the edges of the work hole 61. The mounted shank cover 53 and the upper wall 60 of the shank 12 produce a flush structure. The shank cover 53 has a main body 54 for closing the work hole 61 of the shank 12, and a pair of C-shaped holders 56 and 56 (i.e., fitting portions) which are formed at either side of the main body 54 and fit the curvature of the rivet 63 from the base side of the wiper arm 14. In addition, narrow side walls 57 and 57 are provided at either side of the main body 54 and are located at a center portion of the main body 54 and are oriented along the length thereof. The above holders 56 extend from the side walls 57. At the head side (i.e., the left side in FIG. 7) of the main body 54 of the cover, a pair of fitting portions 58 having an L-shaped form is formed downward, which is fit to the back face of the front edge of the work hole 61 of the shank 12. At the base side (i.e., the right side in FIG. 7) of the main body 54, a fitting hook 59 is provided, which is fit to the rear edge of the work hole 61 of the shank 12.

The fitting portions 58 restrict the main portion 54 of the shank cover 53 from rotating clockwise, while the fitting hook 59 is pushed downward when the main portion 54 is rotated clockwise (as defined by the perspective in FIG. 10), so that the fitting hook 59 is fit to the rear edge of the work hole 61.

At the front side of the upper wall 53a of the main body 54 of the shank cover 53, a non-slip portion 55 is provided for maintaining the cover in place when pushing the front side of the cover. That is, as shown in FIG. 9, when pushing the front side of the upper wall 53a of the shank cover 53 by which the work hole 61 is closed, the fitting hook 59 is separated from the rear edge of the work hole 61 and the shank cover 53 rotates counterclockwise (as defined by the perspective in FIG. 9), so that the shank cover 53 can be removed from the work hole 61.

According to the present embodiment, the wiper blade 13 is rotatably supported by the wiper arm 14. Here, the wiper blade 13 is attached to the joint holder 70 which is rotatably mounted to the wiper arm 14, and this joint holder 70 is covered by and contained in the shank 12 of the wiper arm 14, so that the joint holder 70 is not exposed and can be a small part. Therefore, it is possible to improve the outward appearance of the support 73 of the wiper blade 13 and thus to improve the quality of appearance of the wiper blade 13.

When attaching the wiper blade 13 via the joint holder 70 to the shank 12 of the wiper arm 14, the screws 79 are inserted through the work hole 61 of the shank 12 into the through holes 72 of the joint holder 70 and are screwed into the screw holes 74. Therefore, it is possible to easily perform attachment of the wiper blade 13.

In addition, when replacing the wiper blade 13, the non-slip portion 55 of the shank cover 53 is pushed as shown in FIG. 9, so that the shank cover 53 rotates counterclockwise and the fitting hook 59 at the rear end is separated from the rear edge of the work hole 61. Accordingly, the fitting portions 56 can be separated from the rivet 63, thereby easily detaching the shank cover 53. Here, the rotated shank cover 53 is fit via the fitting portions 56 to the rivet 63 as the rotation shaft of the joint holder 70; thus, the rotating shank cover 53 does not fall from the shank 12 of the wiper arm 14. Therefore, it is easy to handle the shank cover 53.

Furthermore, the joint spacer 31, attached to the joint holder 70, has the extension 31a which extends along the upper wall 33a and the side walls 33b of the primary arm 33 of the wiper blade 13. With this extension 31a, the joint portion between the shank 12 of the wiper arm 14 and the primary arm 33 of the wiper blade 13 can be covered, thereby achieving continuity in appearance from the wiper arm 14 to the wiper blade 13. Therefore, it is possible to reduce whistling sound in wiping operation and to improve the quality of appearance.

In addition, the support 76 (of the joint holder 70) for the rivet 63 is provided close to the head end of the shank 12 of the wiper arm 14. Therefore, the joint holder 70 has a longer portion and a shorter portion on opposite sides of the support 76 (for the rivet 63) as the center point, and the longer portion is close to the base side of the shank 12, thereby stably holding the wiper blade 13.

That is, in rotation of the wiper blade 13 with respect to the shank 12 in the wiping operation via the wiper arm, when the half further from the base of the shank 12 rotates downward around the support 73 (as the rotation center), the other half closer to the base of the shank 12 is received by the shank 12, thereby relatively supporting the wiper blade 13 via the side walls 62 and 62 of the shank 12. Conversely, when the half further from the base of the shank 12 rotates upward around the support 73 (see FIG. 8), the other half closer to the base of the shank 12 leaves the inside of the shank 12 and is not supported by the side walls 62 and 62 of the shank 12. However, in this case, the wiper blade 13 is supported at the support 73 by both side walls 75 and 75 of the joint holder 70 and thus supported by the shank 12 even in this position.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, the present structure can be applied to the wiper apparatus of not only the windshield but also the rear window.

1. A wiper blade connecting structure comprising:
a wiper arm; and
a supporting plate which is rotatably attached to the wiper arm and is covered by the wiper arm, wherein
a wiper blade is attached to the supporting plate and is rotatably supported via the supporting plate by the wiper arm.

2. The wiper blade connecting structure as claimed in claim 1, wherein the wiper arm has a work hole for fastening the supporting plate to the wiper blade.

3. The wiper blade connecting structure as claimed in claim 2, further comprising:
a cover member for covering the work hole, wherein the cover member has a fitting portion which is rotatably fit to a rotation shaft of the supporting plate.

4. The wiper blade connecting structure as claimed in claim 1, further comprising:
a spacer mounted to the supporting plate, wherein the spacer has an extension which extends along a surface of the wiper blade.

5. The wiper blade connecting structure as claimed in claim 1, wherein a support for supporting a rotation shaft of the supporting plate is provided in the supporting plate, in a manner such that the supporting plate has a shorter portion further from a base side of the wiper arm and a longer portion closer to the base side of the wiper arm on opposite sides of the support.

6. The wiper blade connecting structure as claimed in claim 4, wherein a support for supporting a rotation shaft of the supporting plate is provided in the supporting plate, in a manner such that the supporting plate has a shorter portion further from a base side of the wiper arm and a longer portion closer to the base side of the wiper arm on opposite sides of the support.
